(19) United States
(12) Patent Application Publication
(10) Pub. No.: US 2021/0309865 A1
(43) Pub. Date: Oct. 7, 2021

(54) A METHOD OF TREATING A POROUS SUBSTRATE TO INHIBIT OR REDUCE MICROBIAL GROWTH

(71) Applicant: Croda Europe Limited, East Yorkshire (GB)

(72) Inventors: Wilhelmus Adrianus Jacobus HONCOOP, East Yorkshire (GB); Barend VAN DE VELDE, East Yorkshire (GB); Axel VAN DER HOUT, East Yorkshire (GB); Mats Daniel FRIBERG, Arnhem (NL); Anthonie STUIVER, Arnhem (NL); Alexis Theo KARFOPOULOS, Arnhem (NL)

(21) Appl. No.: 17/058,364

(22) PCT Filed: May 24, 2019
(86) PCT No.: PCT/EP2019/063448

§ 371 Date: Nov. 24, 2020

(30) Foreign Application Priority Data
May 25, 2018 (EP) 18174226.3
May 25, 2018 (GB) 1808616.5

(51) Int. Cl. C09D 5/14; A01N 33/02

(52) U.S. Cl. CPC C09D 5/14; A01N 33/02

(57) ABSTRACT

The present invention relates to a method of treating a mineral or textile porous substrate to inhibit or reduce microbial growth in that porous substrate comprising the step of applying an anti-microbial composition to the porous substrate. Suitable anti-microbial compositions comprise one or more quaternary ammonium compounds selected from aminoalkyl(meth)acrylate polymer quats and alkoxylated quats, wherein the or each quaternary ammonium compound comprises an aliphatic C8 to C16 alkyl group, and at least one solvent selected from water and organic solvents. Suitably the anti-microbial composition does not comprise a binder polymer or resin and the quaternary ammonium compound penetrates the porous substrate to inhibit or reduce microbial growth in the porous substrate.

### FIELD OF INVENTION

The present invention relates to a method of treating a porous substrate, an anti-microbial composition, an article comprising a porous substrate and the use of at least one quaternary ammonium compound to inhibit or reduce microbial growth in a porous substrate.

### BACKGROUND

Porous substrates may be susceptible to microbial growth within the substrate due to the pores of the substrate providing a suitable environment for supporting the microbes. A porous substrate treatment composition may be used to reduce or inhibit microbial growth e.g. growth of micro-organisms including but not limited to fungi (for example rot, mold or mildew) bacteria and/or viruses.

An example of a porous substrate treatment composition is a wood preservative formulation. A problem with untreated wood is the susceptibility towards blue stain fungi and wood rot. Wood rot may be caused by various fungi. Propiconazole and iodopropynyl Butyl Carbamate (IPBC) are currently used as active ingredients in wood preservative formulations.

Propiconazole is an azole fungicide, also known as a DMI, or demethylation inhibiting fungicide due to its binding with and inhibiting the 14-alpha demethylase enzyme from demethylating a precursor to ergosterol. Without this demethylation step, the ergosterols are not incorporated into the growing fungal cell membranes, and cellular growth is stopped. Propiconazole is used agriculturally as a systemic fungicide. It is also used in combination with permethrin in formulations of wood preserver.

Iodopropynyl Butyl Carbamate (IPBC) is a water-soluble preservative used globally in the paints & coatings, wood preservatives, personal care, and cosmetics industries. IPBC is a member of the carbamate family of biocides. IPBC was invented in the 1970s and has a long history of effective use as an antifungal technology. IPBC was initially developed for use in the paint & coatings industry as a dry-film preservative to protect interior and exterior coatings from mold, mildew, and fungal growth, while also offering cost performance and sustainability benefits. IPBC today is incorporated into a wide variety of interior and exterior paint formulations around the world.

Use of propiconazole and/or IPBC is restricted in some countries due to their toxicity. Wood preservative formulations comprising a combination of azole fungicides and copper compounds are also known to be effective. A disadvantage of these formulations, however, is that large quantities of toxic azoles still have to be used.

There is therefore a need for a porous substrate treatment composition which inhibits or reduces microbial growth in porous substrates and overcomes one or more disadvantages of the prior art.

### SUMMARY OF THE INVENTION

The present invention is based in part on the recognition that an anti-microbial composition comprising a quaternary ammonium compound (also referred to as a ‘quat’) selected from the group of aminoalkyl(meth)acrylate polymer quats, alkoxylated quats and mixtures thereof, wherein the quaternary ammonium compound comprises a C8 to C16 alkyl chain may advantageously penetrate a porous substrate to a suitable depth, or at s suitable loading level, to inhibit or reduce microbial growth in the porous substrate.

Penetration of the porous substrate by the anti-microbial composition may be improved by the absence of a binder or resin component in the anti-microbial composition. The quaternary ammonium compound of the anti-microbial composition may function effectively as a biocide and/or fungicide within the porous substrate without the need for a further biocide to be present.

Thus, viewed from a first aspect, the invention provides a method of treating a porous substrate to inhibit or reduce microbial growth in the porous substrate comprising the step of applying an anti-microbial composition to the porous substrate, wherein the anti-microbial composition comprises:
a. one or more quaternary ammonium compounds selected from aminoalkyl(meth)acrylate polymer quats and alkoxylated quats, wherein the or each quaternary ammonium compound comprises an aliphatic C8 to C16 alkyl group;
b. at least one solvent selected from water and organic solvents; and
c. optionally other additives;
   wherein the anti-microbial composition does not comprise a binder polymer or resin and wherein the or each quaternary ammonium compound penetrates the porous substrate to inhibit or reduce microbial growth in the porous substrate.

Viewed from a second aspect the invention provides an anti-microbial composition comprising:
a. 0.1 to 15 wt %, based on the total weight of the composition, of one or more quaternary ammonium compounds selected from aminoalkyl(meth)acrylate polymer quats and alkoxylated quats, wherein the or each quaternary ammonium compound comprises an aliphatic C8 to C16 alkyl group;
b. 60 to 99.9 wt %, based on the total weight of the composition, of water;
c. 0 to 25 wt %, based on the total weight of the composition, of organic solvent; and
d. optionally other additives;
   wherein the composition is suitable for treating a porous substrate to inhibit or reduce microbial growth in the porous substrate, and wherein the composition does not comprise any further anti-microbial compounds in addition to the quaternary ammonium compound(s).

Viewed from a third aspect the invention provides an article comprising a porous substrate treated by a method according to the first aspect or with a composition according to the second aspect.

Viewed from a fourth aspect the invention provides the use of at least one quaternary ammonium compound to inhibit or reduce microbial growth in a porous substrate wherein the quaternary ammonium compound is selected from the group of aminoalkyl(meth)acrylate polymer quats, alkoxylated quats and mixtures thereof, wherein the quaternary ammonium compound comprises an aliphatic C8 to C16 alkyl group and wherein the quaternary ammonium compound is applied to the porous substrate in an anti-microbial composition which does not comprise a binder polymer or resin.

Any aspect of the invention may include any of the features described herein with regard to that aspect of the invention or any other aspects of the invention.

### DETAILED DESCRIPTION OF THE INVENTION

It will be understood that any upper or lower quantity or range limit used herein may be independently combined.

It will be understood that, when describing the number of carbon atoms in a substituent group (e.g. ‘C1 to C6’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branch groups.

Many of the chemicals which may be used to produce the present invention are obtainable from natural sources. Such chemicals typically include a mixture of chemical species due to their natural origin. Due to the presence of such mixtures, various parameters defined herein can be an average value and may be non-integral.

The term “microbicide”, “biocide” or “anti-microbial” refers to the capability of killing, inhibiting the growth of, or controlling the growth of microorganisms. The term “microorganism” includes, for example, fungi (such as rot, mold, mildew or yeast), bacteria, viruses and algae.

(Meth)acrylate means methacrylate or acrylate.

A binder polymer or resin as defined herein does not include the quaternary ammonium compound (or quat) defined herein.

### Quaternary Ammonium Compound

The quaternary ammonium compound (or quat) which comprises an aliphatic C8 to C16 alkyl group is selected from aminoalkyl(meth)acrylate polymer quats and alkoxylated quats.

### Aminoalkyl(meth)acrylate Polymer Quat

The aminoalkyl(meth)acrylate polymer quat may comprise one or more aminoalkyl(meth)acrylate monomers. The aminoalkyl(meth)acrylate monomer may be selected from tert-butylaminoethyl(meth)acrylate (tBAEMA), dimethylaminoethyl(meth)acrylate (DMAEMA), diethylaminoethyl(meth)acrylate (DEAEMA), dimethylaminopropyl(meth)acrylate (DMAPMA) and diethylaminopropyl(meth)acrylate (DEAPMA), preferably selected from tert-butylaminoethyl(meth)acrylate (tBAEMA), dimethylaminoethyl(meth)acrylate (DMAEMA) and diethylaminoethyl(meth)acrylate (DEAEMA), more preferably selected from dimethylaminoethyl(meth)acrylate (DMAEMA) and diethylaminoethyl(meth)acrylate (DEAEMA). The aminoalkyl(meth)acrylate polymer quat may comprise one or two species of monomer, preferably one species of monomer. The aminoalkyl(meth)acrylate polymer quat may be a homopolymer or copolymer, preferably a homopolymer. The aminoalkyl(meth)acrylate polymer quat may comprise polymerised DMAEMA.

The aliphatic C8 to C16 alkyl group may have at least 9 carbon atoms, preferably at least 10, more preferably at least 11, desirably at least 12. The aliphatic C8 to C16 alkyl group may have at most 15 carbon atoms, preferably at most 14. The group may be linear. The group may be saturated.

The aliphatic C8 to C16 alkyl group for the aminoalkyl(meth)acrylate polymer quat may be provided by the quaternising agent. The quaternising agent used to quaternise the aminoalkyl(meth)acrylate polymer quat may be selected from organic sulphates, nitrates, phosphates, acetates or halides comprising an aliphatic C8 to C16 alkyl group. Preferably the quaternising agent is an aliphatic C8 to C16 alkyl halide, preferably a chloride or bromide. Preferably the quaternising agent is a C11 to C15 alkyl bromide. Desirably the quaternising agent comprises or is bromo-tetradecane.

The molecular weight of the aminoalkyl(meth)acrylate polymer quat may be measured by gel permeation chromatography (GPC). Suitable GPC settings are described in the Examples. The weight average molecular weight (Mw) of the aminoalkyl(meth)acrylate polymer quat may be at least 20,000 g/mol, preferably at least 50,000, more preferably at least 75,000, particularly preferably at least 100,000, desirably at least 120,000, especially at least 150,000 as measured by GPC. The weight average molecular weight of the aminoalkyl(meth)acrylate polymer quat may be at most 300,000 g/mol as measured by GPC. The number average molecular weight (Mn) of the aminoalkyl(meth)acrylate polymer quat may be at least 10,000 g/mol, preferably at least 20,000, more preferably at least 40,000, particularly preferably at least 60,000, as measured by GPC. The number average molecular weight of the aminoalkyl(meth)acrylate polymer quat may be at most 150,000 g/mol as measured by GPC. The polydispersity index (PDI) of the aminoalkyl(meth)acrylate polymer quat (calculated as Mw/Mn) may be at least 1.5, preferably at least 1.8, more preferably at least 2, particularly at least 2.2, desirably at least 2.4. The polydispersity index of the aminoalkyl(meth)acrylate polymer quat may be at most 10, preferably at most 8, more preferably at most 6.

The percentage (%) cationic active matter content of the aminoalkyl(meth)acrylate polymer quat may be measured according to ISO 2871. The % cationic active matter content may be at least 30%, preferably at least 40%, more preferably at least 50%, particularly at least 52%. The % cationic active matter content may be at most 80%, preferably at most 75%, more preferably at most 70%, particularly at most 68%.

### Alkoxylated Quat

The alkoxylated quat may comprise a core quaternary ammonium group which has pendant groups which comprise:
i) an aliphatic C8 to C16 alkyl group; and
ii) a hydroxyl terminated group, wherein the hydroxyl terminated group comprises from 1 to 10 alkylene oxide residues.

The aliphatic C8 to C16 alkyl group may have at least 9 carbon atoms, preferably at least 10, more preferably at least 11, desirably at least 12. The aliphatic C8 to C16 alkyl group may have at most 15 carbon atoms, preferably at most 14. The group may be linear. The group may be saturated. The aliphatic C8 to C16 alkyl group may be R¹ in formula (I).

The alkoxylated quat may comprise a core quaternary ammonium group which has pendant groups which comprise ii) two independent hydroxyl terminated groups, wherein each hydroxyl terminated group independently comprises from 1 to 10 alkylene oxide residues.

The or each hydroxyl terminated group comprises from 1 to 10 alkylene oxide residues. The alkylene oxide residues in each group are typically present as a polyalkylene oxide chain. Each polyalkylene oxide chain preferably has the formula: —(CᵣH₂ᵣO)_{q}— where q is the number of alkylene oxide residues in the chain and r is 2, 3 or 4, preferably 2 or 3, i.e. an ethyleneoxy (—C₂H₄O—) or propyleneoxy (—C₃H₆O—) group. There may be different alkylene oxide residues along each polyalkylene oxide chain. It is desirable that each polyalkylene oxide chain is a homopolymeric ethylene oxide chain. However, the chain may be a homopolymeric chain of propylene oxide residues or a block or random copolymer chain containing both ethylene oxide and propylene oxide residues. The molar amount of ethylene oxide residues as a percentage of total alkylene oxide residues in the alkoxylated quat may be at least 50 mol %, preferably at least 70 mol %, more preferably at least 80 mol %. The molar amount of ethylene oxide residues as a percentage of total alkylene oxide residues in the alkoxylated quat may be at most 100 mol %, preferably at most 90 mol %, more preferably at most 80 mol %. The molar amount of ethylene oxide residues as a percentage of total alkylene oxide residues in the alkoxylated quat may be 100%.

The average number of alkylene oxide residues in each polyalkylene oxide chain of the quaternary ammonium compound, i.e. the value of parameter q, or the independent values of m and n in formula (I), is preferably in the range from 1 to 10, more preferably from 1 to 8, particularly from 2 to 6, desirably from 2 to 4.

The total number of alkylene oxide residues in the alkoxylated quat i.e. the sum of m+n in formula (I), is preferably at least 2, more preferably at least 3, particularly at least 4, desirably at least 5. The total number of alkylene oxide residues in the alkoxylated quat i.e. the sum of m+n in formula (I), is preferably at most 16, more preferably at most 14, particularly at most 12, desirably at most 10, especially at most 8.

Preferably the alkoxylated quat comprise from 2 to 20 alkylene oxide residues in total in the compound and wherein the alkylene oxide residues are selected from ethylene oxide and propylene oxide.

The alkoxylated quat preferably comprises from 1 to 4 quaternary ammonium groups. The alkoxylated quat may comprise from 2 to 4 quaternary ammonium groups. Two quaternary ammonium groups in the alkoxylated quat may be connected via a divalent linking group which is pendant to both quaternary ammonium groups.

The core quaternary ammonium group of the alkoxylated quat preferably has a further pendant group iii) which comprises a C1 to C8 hydrocarbyl group, more preferably a C1 to C6 alkyl group, particularly a C1 to C4 alkyl group and desirably a methyl group.

The quaternising agent used to form the alkoxylated quat may be selected from organic sulphates, nitrates, phosphates, acetates or halides, preferably organic halides, particularly alkyl halides. The quaternising agent may comprise methyl chloride or bromide, preferably methyl chloride.

Preferably, the alkoxylated quat is of formula (I):

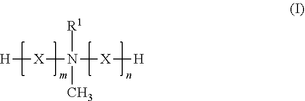

wherein:
IR′ is an aliphatic C8 to C16 alkyl group;
m and n independently have a value from 1 to 10, preferably from 1 to 8, particularly preferably from 2 to 6;
the sum of m+n is from 2 to 16; and
each X is independently selected from an ethylene oxide residue terminating at —O and a propylene oxide residue terminating at —O; such that the compound of formula (I) comprises two terminal hydroxyl groups.

The features and preferences described herein for the alkoxylated quat are also features and preferences applicable to formula (I).

The % cationic active matter content of the alkoxylated quat may be measured according to ISO 2871. The % cationic active matter content may be at least 50%, preferably at least 60%, more preferably at least 70%, particularly at least 80%. The % cationic active matter content may be at most 95%.

### Anti-Microbial Composition

The anti-microbial composition may comprise at least 0.1 wt % of the quaternary ammonium compound, preferably at least 0.2 wt %, more preferably at least 0.5 wt %, particularly at least 1 wt %, desirably at least 2 wt %, especially at least 3 wt % on the basis of the total weight of the composition. The composition may comprise at most 10 wt % of the quaternary ammonium compound, preferably at most 8 wt %, more preferably at most 6 wt %, particularly at most 4 wt %, desirably at most 2 wt % on the basis of the total weight of the anti-microbial composition.

The anti-microbial composition preferably comprises at least one quaternary ammonium compound selected from aminoalkyl(meth)acrylate polymer quats and at least one quaternary ammonium compound selected from alkoxylated quats, wherein each quaternary ammonium compound comprises an aliphatic C8 to C16 alkyl group.

The weight ratio of aminoalkyl(meth)acrylate polymer quats to alkoxylated quats in the anti-microbial composition may be at most 10:1, preferably at most 8:1, more preferably at most 4:1, particularly at most 2:1, desirably at most 1:1. The weight ratio of aminoalkyl(meth)acrylate polymer quats to alkoxylated quats in the anti-microbial composition may be at least 0.1:1, preferably at least 0.2:1, more preferably at least 0.4:1, particularly at least 0.8:1, desirably at least 1:1.

Preferably, the anti-microbial composition comprises at least 50 wt % water, more preferably at least 60 wt % water, particularly at least 75 wt % water, desirably at least 80 wt % water, especially at least 85 wt % water, all based on the total weight of the anti-microbial composition.

The weight ratio of water to quaternary ammonium compound in the anti-microbial composition may be at most 40:1, preferably at most 30:1, more preferably at most 20:1, particularly at most 10:1. The weight ratio of water to quaternary ammonium compound in the anti-microbial composition may be at least 1:1, preferably at least 2:1, more preferably at least 4:1, particularly at least 6:1, desirably at least 8:1, especially at least 10:1.

The anti-microbial composition may comprise one or more organic solvents. The organic solvent may be selected from the group consisting of glycols, esters and alcohols, preferably selected from glycols and alcohols, more preferably selected from glycols. The organic solvent may be a polar solvent.

The weight ratio of organic solvent to quaternary ammonium compound in the anti-microbial composition may be at most 10:1, preferably at most 5:1, more preferably at most 4:1, particularly at most 3:1. The weight ratio of organic solvent to quaternary ammonium compound in the anti-microbial composition may be at least 0.5:1, preferably at least 1:1, more preferably at least 1.2:1, particularly at least 1.4:1, desirably at least 1.5:1.

Preferably the organic solvent comprises one or more glycols. Preferably the organic solvent comprises a polyalkylene glycol, more preferably polyethylene glycol. Preferably the organic solvent comprises an alkyldiglycol, more preferably butyldiglycol.

The glycol solvent may be selected from the group consisting of ethylene glycol, diethylene glycol, triethylene glycol, polyethylene glycol (PEG), propylene glycol, dipropylene glycol, tripropylene glycol, polypropylene glycol (PPG) and alkyldiglycols, preferably selected from polyethylene glycol, polypropylene glycol and alkyldiglycols, more preferably selected from polyethylene glycol and alkyldiglycols.

The weight ratio of polyalkylene glycol to quaternary ammonium compound in the anti-microbial composition may be at most 10:1, preferably at most 5:1, more preferably at most 4:1, particularly at most 3:1. The weight ratio of organic solvent to quaternary ammonium compound in the anti-microbial composition may be at least 0.5:1, preferably at least 1:1, more preferably at least 1.2:1, particularly at least 1.4:1, desirably at least 1.5:1.

The ester solvent may be selected from the group consisting of amyl acetate, dibasic ester, ethyl acetate, 2-ethyl hexyl acetate, ethyl propionate, acetate esters, isobutyl acetate, isobutyl isobuterate, isopropyl acetate, n-butyl acetate, n-butyl propionate, n-pentyl propionate, and n-propyl acetate.

The alcohol solvent may be selected from the group consisting of amyl alcohol, benzyl alcohol, cyclohexanol, ethyl alcohol, 2-ethyl hexanol, isooctyl alcohol, isodecyl alcohol, tridecyl alcohol, furfuryl alcohol, isobutyl alcohol, methanol, methyl amyl alcohol, methyl isobutyl carbinol (MIBC), n-butyl alcohol, n-propyl alcohol, secondary butyl alcohol, tertiary butyl alcohol, and tetrahydrofurfuryl alcohol.

The anti-microbial composition preferably comprises from 0 to 25 wt %, based on the total weight of the composition, of organic solvent. The anti-microbial composition may comprise at least 0.1 wt % of organic solvent, preferably at least 1 wt %, more preferably at least 2 wt %, particularly at least 4 wt %, desirably at least 8 wt % based on the total weight of the composition. The anti-microbial composition may comprise at most 24.9 wt % of organic solvent, preferably at most 22 wt %, more preferably at most 20 wt %, particularly at most 15 wt %, desirably at most 10 wt %.

The anti-microbial composition may consist of the quaternary ammonium compound (or compounds), water and the organic solvent.

Preferably the anti-microbial composition comprises:
a. 0.1 to 15 wt %, based on the total weight of the composition, of one or more quaternary ammonium compounds selected from aminoalkyl(meth)acrylate polymer quats and alkoxylated quats, wherein the or each quaternary ammonium compound comprises an aliphatic C8 to C16 alkyl group;
b. 60 to 99.9 wt %, based on the total weight of the composition, of water;
c. 0 to 25 wt %, based on the total weight of the composition, of organic solvent; and
d. optionally other additives;
   wherein the composition is suitable for treating a porous substrate to inhibit or reduce microbial growth in the porous substrate, and wherein the composition does not comprise any further anti-microbial compounds in addition to the quaternary ammonium compound(s).

Preferably the composition does not comprise a binder polymer or resin. However, in an alternative and less preferred embodiment, the composition may comprise less than 15 wt % binder polymer or resin, preferably less than 10 wt %, more preferably less than 5 wt %, particularly less than 2 wt %, desirably less than 1 wt %. Preferably, the composition may comprise substantially no binder polymer or resin. The presence of such a binder is believed to adversely affect the ability of the anti-microbial composition to penetrate in to the pores of the porous substrate.

### Optional Other Additives

The anti-microbial composition may comprise one or more optional other additives. These additives may be selected from pigments, dyes, catalysts, rheology modifiers, wetting agents, defoamers, stabilisers, fillers, emulsifiers, dispersants and surfactants.

The anti-microbial composition may comprise a pigment. Examples of organic pigments are azo pigments, phthalocyanine, and quinacridone. Examples of inorganic pigments are iron oxide pigments, titanium dioxide and carbon black.

The anti-microbial composition may comprise a dye. Examples of dyes are azo, azine, anthraquinone, acridine, cyanine, oxazine, polymethine, thiazine and triarylmethane dyes. These dyes may be employed as basic or cationic dyes, metal complex, reactive, acid, sulfur, coupling or substantive dyes.

The anti-microbial composition may comprises at least one pigment or dye. In an alternative embodiment, the anti-microbial composition may comprise no pigment or dye.

The anti-microbial composition may comprise a stabiliser. Suitable stabilizers include materials which stabilize the viscosity of the anti-microbial composition during its production, storage and application, and include monofunctional carboxylic acid chlorides and non-corrosive inorganic acids. Examples of such stabilizers are benzoyl chloride, phosphoric acid or phosphorous acid. In addition, suitable hydrolysis stabilizers include for example the carbodiimide type. Stabilizers which are antioxidants or UV absorbers may also be used. Examples of such stabilizers are HALS hindered amine light stabilisers, hydrogen-donating antioxidants such as hindered phenols and secondary aromatic amines, benzofuranone, oxanilides, benzophenones, benzotriazoles and UV absorbing pigments.

The anti-microbial composition may comprise a surfactant. Suitable surfactants include silicone surfactants such as dimethylpolysiloxane, polyoxyalkylene polyol-modified dimethylpolysiloxane and alkylene glycol-modified dimethylpolysiloxane; and anionic surfactants such as fatty acid salts, sulphuric acid ester salts, phosphoric acid ester salts and sulphonates. Preferably the anti-microbial composition comprises at least one surfactant selected from anionic surfactants and non-ionic surfactants.

The anti-microbial composition may comprise a filler. Suitable fillers include inorganic fillers such as clay, chalk, and silica.

The anti-microbial composition may comprise at least 0.5 wt %, preferably at least 1 wt %, particularly at least 2 wt % of such other additives, based on the total weight of the composition. The anti-microbial composition may comprise at most 15 wt %, preferably at most 10 wt %, particularly at most 6 wt %, desirably at most 4 wt % of such other additives, based on the total weight of the composition.

### Porous Substrate

The porous substrate of the invention includes any substrate which comprises surface pores which can be penetrated by the anti-microbial composition but does not comprise living skin of animals such as live human or live animal skin.

Examples of suitable porous substrates include wood, paper, wood-pulp products and other cellulosic materials, concrete, mortar, plaster, grout, masonry, brick, ceramics and other mineral materials, and textile materials, both woven (including knitted) and non-woven textiles.

Preferably the porous substrate is selected from wood-pulp products, concrete, mortar, plaster, grout, masonry, brick, ceramics, woven textiles and non-woven textiles. More preferably the porous substrate is selected from concrete, mortar, plaster, grout, masonry, brick, ceramics, woven textiles and non-woven textiles. Particularly preferably, the porous substrate is selected from woven textiles and non-woven textiles.

The porous substrate may be a mineral or textile material, preferably a textile material. In this context a mineral material may be understood to mean any material which is solid at ambient temperature and pressure and its major constituent is not plant or vegetable derived. However, on the other hand, a textile material may encompass materials which are plant or vegetable derived (often referred to as natural materials), and may include for example, silk, wool, flax, cotton, hemp, bamboo, modal or rayon majority containing textiles. Additionally, or alternatively, a textile material may also encompass synthetic majority containing textiles, and may include for example, synthetic textiles such as geotextiles, polyesters, polyurethanes and polylactides. A suitable textile may also be a mixed material comprising roughly equal natural and synthetic derived constituents, for example as in a poly-cotton woven textile or a wool and nylon knitted textile.

### Treated Article

The present invention also provides an article comprising a porous substrate treated by a method according to the invention or with a composition according to the invention.

Preferably the pores of the porous substrate comprise a quaternary ammonium compound as defined herein.

The quaternary ammonium compound(s) may penetrate the porous substrate to a depth of at least 0.2 mm, preferably at least 0.4 mm, more preferably at least 0.6 mm, particularly at least 0.8 mm, desirably at least 1 mm. In one embodiment, the quaternary ammonium compound(s) may penetrate the porous substrate of the article to a depth of at least 2 mm, preferably at least 3 mm.

Additionally, or alternatively, the quaternary ammonium compound(s) may penetrate the porous substrate to a loading level of at least 0.1 g of quaternary ammonium compound per m² of substrate surface area (g/m²), more preferably to a loading level of at least 0.5 g/m², particularly to a loading level of at least 1 g/m², desirably to a loading level of at least 1.5 g/m². Preferably to a loading level of at most 20 g of quaternary ammonium compound per m² of substrate (g/m²), more preferably to a loading level of at most 15 g/m², particularly to a loading level of at most 10 g/m², desirably to a loading level of at most 5 g/m², especially to a loading level of at most 3 g/m².

Preferably the article comprises at least one quaternary ammonium compound selected from aminoalkyl(meth)acrylate polymer quats and at least one quaternary ammonium compound selected from alkoxylated quats, wherein each quaternary ammonium compound comprises an aliphatic C8 to C16 alkyl group.

The article may be a textile article. The textile article may be an item of clothing, a filter, a geotextile (i.e. a textile for use in the ground), a decorative textile, a flooring textile or a furnishing textile.

The article may be a mineral article. The mineral article may comprise concrete, mortar, plaster, grout, masonry, brick or ceramic. The article may be a plaster article. The plaster article may be a plaster sheet, preferably a drywall sheet.

### Coating Composition

A coating composition may be applied after the anti-microbial composition is applied to the substrate. The coating composition may advantageously reduce the rate of leaching of the quaternary ammonium compound out of the substrate. The coating composition may form a protective coating on the substrate. The coating composition may cure to form a protective coating on the substrate. The coating composition may be a paint or a lacquer. Additionally, or alternatively, the coating compositions may be a textile protection finish layer. Suitable textile protection finish layers may provide stain repellency, water repellency or water proofing as desired. Such textile protection finish layer may preferably be applied to the substrate via any suitable method including a coating bar, coating blade (or knife) or spray method. Dip coating methods, although contemplated, are less preferred as saturation of the substrate (and of a textile substrate in particular) by the coating composition may displace the anti-microbial composition from the substrate pores.

Preferably, for some applications, the coating composition comprises a binder polymer or resin. The binder polymer or resin may comprise one or more of:
(i) Crosslinkable polymers derived from aldehydes on the one hand and phenols, ureas and melamines on the other hand, such as phenol/formaldehyde resins, urea/formaldehyde resins and melamine/formaldehyde resins;
(ii) Drying and nondrying alkyd resins;
(iii) Unsaturated polyester resins derived from copolyesters of saturated and unsaturated dicarboxylic acids with polyhydric alcohols and vinyl compounds as crosslinking agents, and also halogen-containing modifications thereof of low flammability;
(iv) Crosslinkable acrylic resins derived from acrylates, acrylamides or substituted acrylates, for example epoxy acrylates, urethane acrylates or polyester acrylates, preferably comprising no quaternary ammonium groups;
(v) Crosslinkable alkyd resins, polyester resins, polyether resins and acrylate resins crosslinked with melamine resins, urea resins, polyisocyanates or epoxy resins; and
(vi) Crosslinkable epoxy resins derived from polyepoxides, for example from bisglycidyl ethers or from cycloaliphatic diepoxides.

Preferably, the coating composition comprises a polyurethane, alkyd and/or acrylic binder, more preferably an alkyd and/or acrylic binder. Preferably the binder comprises no quaternary ammonium groups.

The coating composition may have a total solids content, according to DIN EN ISO 3251, of at least 25 wt %, preferably at least 30 wt %, more preferably at least 35 wt %, particularly at least 40 wt %, based on the total weight of the coating composition. The coating composition may have a total solids content of at most 80 wt %, preferably at most 70 wt %, more preferably at most 65 wt %, particularly at most 60 wt %, based on the total weight of the coating composition.

The coating composition may be a solvent borne (SB) coating composition, comprising no, or essentially no water. Alternatively, the coating composition may comprise at least 10 wt % water, preferably at least 20 wt % water, particularly at least 30 wt % water, all based on the total weight of the coating composition. The coating composition may comprise at most 90 wt % water, preferably at most 80 wt % water, particularly at most 70 wt % water, all based on the total weight of the coating composition.

The coating composition may be applied at temperatures ranging from about 0° C. to about 50° C., preferably from 10° C. to 40° C. Preferably the coating composition is curable at ambient temperature (e.g. 20° C. to 30° C.). The coating composition may be curable without the use of an additional heat source.

Preferably the coating composition forms a continuous solid film layer on the surface of the porous substrate.

### Method of Treating a Porous Substrate

The invention provides a method of treating a porous substrate as defined herein.

The quaternary ammonium compound may penetrate the porous substrate via the pores of the porous substrate. Penetration of the quaternary ammonium compound into the pores of the porous substrate can be obtained by allowing the quaternary ammonium compound to enter the pores under atmospheric pressure or by applying a vacuum or higher pressure to enhance penetration (deeper penetration). Suitably, the quaternary ammonium compound is carried into the pores of the porous substrate via an anti-microbial composition as described herein.

The quaternary ammonium compound may penetrate the porous substrate to a depth of at least 0.2 mm, preferably at least 0.4 mm, more preferably at least 0.6 mm, particularly at least 0.8 mm, desirably at least 1 mm. In one embodiment, the quaternary ammonium compound(s) may penetrate the porous substrate to a depth of at least 2 mm, preferably at least 3 mm.

It is understood that in order to obtain a proper protection, the anti-microbial composition of the invention should penetrate the substrate, so preferably it should not form a continuous solid film layer on the surface of the porous substrate. This is in contrast with a coating such as a paint or a lacquer which does form a solid film on top of the substrate. Preferably the anti-microbial composition does not form a continuous solid film layer on the surface of the porous substrate.

Preferably the method comprises the step of applying a coating composition after applying the anti-microbial composition wherein the coating composition comprises a binder polymer or resin. Preferably the coating composition and binder polymer or resin are as described herein. Preferably the coating composition forms a continuous solid film layer on the surface of the porous substrate.

Preferably the step of applying the anti-microbial composition to the porous substrate comprises applying the anti-microbial composition at a loading level of at least 0.1 g of quaternary ammonium compound per m² of substrate surface area (g/m²), more preferably applying at a loading level of at least 0.5 g/m², particularly applying at a loading level of at least 1 g/m², desirably applying at a loading level of at least 1.5 g/m². Preferably the step of applying the anti-microbial composition to the porous substrate comprises applying at a loading level of at most 20 g of quaternary ammonium compound per m² of substrate (g/m²), more preferably applying at a loading level of at most 15 g/m², particularly applying at a loading level of at most 10 g/m², desirably applying at a loading level of at most 5 g/m², especially applying at most 3 g/m².

### Use of the Quat(s) to Inhibit or Reduce Microbial Growth in a Porous Substrate

The invention provides the use of at least one quaternary ammonium compound to inhibit or reduce microbial growth in a porous substrate as defined herein.

Preferably the quaternary ammonium compound is as defined herein.

The use preferably comprises at least one quaternary ammonium compound selected from aminoalkyl(meth)acrylate polymer quats and at least one quaternary ammonium compound selected from alkoxylated quats, wherein each quaternary ammonium compound comprises an aliphatic C8 to C16 alkyl group.

Any or all of the features described herein, and/or any or all of the steps of any method or process described, may be used in any combination in any aspect of the invention.

### EXAMPLES

The invention is illustrated by the following non-limiting examples.

It will be understood that all test procedures and physical parameters described herein have been determined at atmospheric pressure, room temperature (i.e. about 20° C.) and a relative humidity of 50% unless otherwise stated herein, or unless otherwise stated in the referenced test methods and procedures.

All parts and percentages are given by weight unless otherwise stated.

Compounds used in the examples are identified as follows:
BLX Pro (TM)—a coating composition (ex AkzoNobel) comprising a combination of acrylic binder and alkyd binder and modified to include no biocide.
PEG400—polyethylene glycol with an average molecular weight of 400.

### Test Methods

In this specification, the following test methods have been used:

(i) Number average molecular weight and weight average molecular weight were determined by GPC using hexafluoroisopropanol as the solvent and measured against a set of polymethylmethacrylate standards using a third order polynomial. The following GPC apparatus was used:
Alliance 2690 system consisting of a pump, auto sampler and degasser
Waters 410 Refractive index (RI) detector
Data processing system with Millennium 32 Chromatography manager from Waters
PFG (Polar Fluoro Gel) 7 μm linear gel column (300×8 mm), Polymer Standards Services (PSS)
Flow: 0.6 ml/min
Sample concentration: 1.5-1.8 mg/ml (solid polymer)
Injection volume: 50 μl.
   (ii) The hydroxyl value is defined as the number of mg of potassium hydroxide equivalent to the hydroxyl content of 1 g of sample, and was measured by acetylation followed by hydrolysation of excess acetic anhydride. The acetic acid formed was subsequently titrated with an ethanolic potassium hydroxide solution.
   (iii) The acid value is defined as the number of mg of potassium hydroxide required to neutralise the free fatty acids in 1 g of sample, and was measured by direct titration with a standard potassium hydroxide solution.
   (iv) The % cationic active matter content in a cationic quaternary ammonium compound with known molecular weight was determined using a titration with anionic solution according to ISO 2871. The % cationic active matter content is equivalent to the percentage of tertiary nitrogen groups in the sample which have been quaternised.
   (v) Substrate penetration depth of the blue stain fungi inhibition zone (mm) was determined using a modified version of NEN-EN 152 with a shortened incubation time and without artificial or natural weathering. The test fungi used in all blue stain tests were Aureobasidium pullulans (SCC015) and Sydowia polyspora (DSMZ). The test fungi were used as a mixed culture in the form of a spore suspension. The basic principles of the test method used, was to provide the conditions for infection by blue-stain fungi into the treated face of the substrate and into the cut surface behind the treated face and observe the development of infection into the treated face. A series of wood samples of Pinus sylvestris (Scotch pine) were treated on one face with an amount of anti-microbial composition so that 2.1 g/m² of quat was applied to the wood sample surface. Dimensions of the wood samples were 55×35×4 mm. Test specimens were exposed in the laboratory to the action of a mixed culture of two fungi causing blue-stain in service. For purposes of comparison, an appropriate reference product of known performance was included in the test; one positive (blue stain growth) and one negative (no blue stain growth/no treatment with fungi). Two replicates is per sample were used. At the end of the test, when the positive control shows clear signs of blue stain (Rating +++), and the negative control is still free of blue stain (Rating 0), samples were examined visually for the presence of blue stain. Samples were rated as follows:

| Rating | Category | Observation |
|---|---|---|
| 0 | not blue | no blue stain can be detected visually on |
| | stained | the surface |
| + | insignificantly | the surface exhibits only individual small |
| | blue stained | blue stained spots |
| ++ | blue stained | The surface is continuously blue stained up to |
| | | a maximum, of one third, or blue stained |
| | | partially or in streaks up to half the total |
| | | area |
| +++ | Strongly blue | More than one third of the surface is |
| | stained | continuously blue stained or more than half |
| | | is partially blue stained |

Penetration of the substrate by the anti-microbial composition was determined by measuring the depth at which no blue stain had developed (the blue stain inhibition zone) measured from the surface onto which the anti-microbial composition was applied (in other words, the distance from the treated surface to the inside the wood panel where the blue stain had developed).

(vi) Leaching of the treated wood samples prior to fungal test was performed by applying the anti-microbial composition to the wood sample surface, allowing the samples to dry for 24 h, followed by placing the samples in glass jars, filled with 300 ml of demineralised water with the treated face of the samples facing downwards, into the water. After 24 h, the samples were removed from the glass jars and allowed to dry (at least 24 h) prior to the blue stain test.

### Example 1

An aminoalkyl(meth)acrylate polymer quat according to the invention was synthesised as follows using the ingredients listed in Table 1.

TABLE 1

| | | Wt % in Poly-quat |
|---|---|---|
| Compound | Function | product |
| Bromo-tetradecane | Quaternising agent | 5.8 |
| PEG400 | Solvent & Carrier | 18.5 |
| DMAEMA | Amino-methacrylate | 5.4 |
| | monomer | |
| Butyldiglycol (BDG) | Solvent | 2.4 |
| Di-tert-butyl peroxide | Polymerisation Initiator | 0.3 |
| (DTBP) | | |
| Water | Diluent | 67.6 |

The dimethylaminoethylmethacrylate (DMAEMA) monomer, PEG400 and bromo-tetradecane were mixed in suitable apparatus and heated at 120° C. for 2 hours to quaternise the DMAEMA with the bromo-tetradecane. Once the desired amount of quaternisation to achieve a % cationic active matter content of about 60% determined by ISO 2871 was obtained, the mixture was cooled to allow addition of the polymerisation initiator. The BDG solvent and DTBP initiator were added to the mixture to initiate polymerisation of the DMAEMA. The polymerisation reaction was continued for about 1 hour at 120° C. and then 15 minutes at 140° C. to achieve the desired weight average molecular weight of the aminoalkyl(meth)acrylate polymer quat, measured by GPC as described in the Test Methods. The weight average molecular weight was measured as 196,000 g/mol and the number average molecular weight was measured as 68,000 g/mol, giving a polydispersity index of 2.88. The product was then diluted with water.

The resulting product is referred to herein as the Poly-quat Product and it comprises 11.5 wt % of the aminoalkyl(meth)acrylate polymer quat, 18.5 wt % of PEG400, 2.4 wt % of butyldiglycol and the remainder water (67.6 wt %).

### Example 2

An alkoxylated quat according to the invention was synthesised as follows.

100 parts by weight of cocoamine-2EO (the cocoamine-2EO is an amine derived from coconut fatty acid which comprises C12 alkyl amine which has then been ethoxylated with 2 mols of ethylene oxide—hence 2EO) and 0.17 parts by weight catalyst (caustic potash, 45 wt % in water) were charged to a pressurised reactor (Parr). With agitation and nitrogen sweep on the temperature was raised to 150-160° C. slowly. Upon reaching this temperature, ethylene oxide is feed to the reactor. The reaction was held at this temperature for 2 hours after the addition until the desired acid and hydroxyl values were obtained. The resulting product contained 5 ethylene oxide residues (5EO) in total. This intermediate is referred to as cocoamine-5EO. 100 parts by weight (1 mol) of the cocoamine-5EO was charged to a pressurised reactor (Parr) with agitation and nitrogen sweep on. The temperature was raised to 75-80° C. and 1 psi pressure with N₂ for 30 minutes. 8.6 parts by weight (1 mol) of Methyl Chloride was added to the reactor to quaternise the cocoamine-5EO. The reaction was continued until the desired amount of quaternisation was obtained.

The resulting product is referred to herein as the Coco-5EO-quat Product. The % cationic active matter content of the Coco-5EO-quat Product was tested according to ISO 2871 and determined to be at least 90%.

### Example 3

The Poly-quat Product of Example 1 and the Coco-5EO-quat Product of Example 2 were tested in anti-microbial compositions for penetration of a wood substrate and inhibition of blue stain fungi growth with and without leaching as described herein in the Test Methods. The anti-microbial compositions for the Poly-quat Product and for the Coco-5EO-quat Product were diluted with sufficient water so that a standard amount of 2.1 g/m² of quat was applied to the relevant wood samples.

In the first set of tests, no further coating composition was applied after the anti-microbial composition had been applied to the wood substrate. In the second set of tests, a coating of BLX Pro (as described above) was applied after the anti-microbial composition had been applied. One group of the treated wood samples was then leached as described in the Test Methods and another group was not leached.

The results of the tests are given in Table 2. Substrate penetration depth was measured as described in the Test Methods.

TABLE 2

| | Substrate penetration depth - blue stain | | | |
|---|---|---|---|---|
| Anti-microbial | inhibition zone (mm) | | | |
| composition | Without BLX Pro coating | | With BLX Pro | |
| comprising | No leaching | Leached | No leaching | Leached |
| Poly-quat | 0.7 | 0.6 | 0.7 | 0.4 |
| Product | | | | |
| Coco-5EO- | 3.3 | 1.1 | 3.4 | 3.4 |
| quat Product | | | | |

It can be seen from the results in Table 2 that both Poly-quat and Coco-5EO-quat are successful in penetrating the porous substrate of the wood sample and inhibiting blue stain fungi growth. The Poly-quat has a lower penetration but resists leaching more than the Coco-5EO-quat. The addition of the BLX Pro coating composition after the Coco-5EO-quat completely prevents leaching of the Coco-5EO-quat.

### Example 4

The Poly-quat Product of Example 1 was tested for antimicrobial activity in a polyester porous nonwoven textile substrate. The Product was applied at a loading level as indicated below:

Blank (0.0 g/m² applied loading level as solid Poly-quat)

Sample 1 (1.0 g/m² applied loading level as solid Poly-quat)

Sample 2 (5.0 g/m² applied loading level as solid Poly-quat)

Sample 3 (10.0 g/m² applied loading level as solid Poly-quat)

The samples were tested for antimicrobial activity in accidence with JIS Z 2801/ISO 22196 which is suitable for testing antibacterial activity and efficacy of plastic surfaces. The micro-organisms tested against are given in Table 3. For each test 0.1 ml of a freshly made suspension of the testing micro-organism is applied (in small droplets at a concentration rate of the organism of 105-106 cells/ml) to the sample to be tested in a petri dish to provide an inoculated test material. The inoculated test material is then left incubating for a period of 24 hours at 35° C.

After incubation, the number of surviving bacteria is determined by washing off the viable microbes with 10 ml of suitable broth. This wash off solution is collected in a petri dish and agar (Plate Count Agar, PCA) is added and mixed. The PCA plates are incubated overnight at 35° C., where after the number of colonies assessed. Table 4 show the antimicrobial efficacy of the samples tested.

In addition, the samples are also subject to a washing cycle performed using 25 litre demineralised water per square metre. The samples were exposed for 24 hours and then dried for at least 24 hours more. Subsequently, these washed samples were tested for antimicrobial activity in accidence with JIS Z 2801/ISO 22196, as briefly described above. Table 5 shows the antimicrobial efficacy of the washed samples tested.

TABLE 3
Test micro-organisms.

| Name | ID number | Description |
|---|---|---|
| Staphylococcus. simulans | DSM 20322 | Gram positive bacteria |
| Escherichia coli | DSM 498 | Gram negative bacteria |
| Aspergillus niger | ATCC 6275 | Fungi |

TABLE 4
Antimicrobial activity (No Washing)

| | Log reduction | | | Percentage decrease (%) | | |
|---|---|---|---|---|---|---|
| | A. niger | E. coli | S. simulans | A. niger | E. coli | S. simulans |
| blank | 0.8 | 0.3 | 1.9 | 84.7 | 48.0 | 98.7 |
| Sample 1 | 1.7 | 0.6 | 2.4 | 98.0 | 72.3 | 99.6 |
| Sample 2 | 4.0 | 4.0 | 4.0 | 100.0 | 100.0 | 100.0 |
| Sample 3 | 3.7 | 4.0 | 4.0 | 100.0% | 100.0% | 100.0% |

TABLE 5
Antimicrobial activity after a washing cycle

| | Log reduction | | | Percentage decrease (%) | | |
|---|---|---|---|---|---|---|
| | A. niger | E. coli | S. simulans | A. niger | E. coli | S. simulans |
| Blank | 0.2 | 0.0 | 1.1 | 40.0 | 0.0 | 91.6 |
| Sample 1 | 1.4 | 0.3 | 2.7 | 96.0 | 49.2 | 99.8 |
| Sample 2 | 3.6 | 2.9 | 4.0 | 100.0 | 99.9 | 100.0 |
| Sample 3 | 3.7 | 4.0 | 4.0 | 100.0 | 100.0 | 100.0 |

A log reduction of 2.0 and higher is considered to be antimicrobial and 3.0 and higher is considered to be strongly antimicrobial.

The blank shows a slight effect on microbial growth; however, this effect is at a level insufficient to be considered antimicrobial. Appling a loading level of 1 g/m² of Product to the nonwoven textile shows some improvement in particular with the A. niger, but a 5 g m² or 10 g m² applied loading level gives desirably strong and durable antimicrobial protection. It can be seen that sample 3 has lost no effectiveness after a washing cycle.

The washing test shows that the effect from the blank sample is coming from residual surfactants/additives. The shortened washing step (1×24 hours) mostly removed the effect of the blank. The other samples lost little to no efficacy to the washing step.

The blank shows a slight effect on microbial growth; however, it is insufficient to be antimicrobial. Adding 1.0 g/m² of sample 1 shows some improvement in particular with the A. niger, but sample 2 (5 g/m²) or sample 3 (10 g/m²) is needed to give a sufficiently strong and durable antimicrobial protection.

It is to be understood that the invention is not to be limited to the details of the above embodiments, which are described by way of example only. Many variations are possible within the scope of the claims as annexed hereto.

1. A method of treating a porous substrate comprising applying an anti-microbial composition to the porous substrate, wherein the anti-microbial composition comprises:
a. one or more quaternary ammonium compounds selected from aminoalkyl(meth)acrylate polymer quats and alkoxylated quats, wherein the or each quaternary ammonium compound comprises an aliphatic C8 to C16 alkyl group;
b. at least one solvent selected from water and organic solvents; and
c. optionally other additives;
wherein the anti-microbial composition does not comprise a binder polymer or resin and wherein the or each quaternary ammonium compound penetrates the porous substrate to inhibit or reduce microbial growth in the porous substrate; wherein the porous substrate is a mineral or textile material.

2. The method according to claim 1, wherein the quaternary ammonium compound penetrates the porous substrate to a depth of at least 0.2 mm.

3. The method according to claim 1, wherein the anti-microbial composition does not form a continuous solid film layer on the surface of the porous substrate.

4. The method according to claim 1, further comprising applying a coating composition to the porous substrate after applying the anti-microbial composition, wherein the coating composition comprises a binder polymer or resin.

5. The method according to claim 1, wherein the anti-microbial composition comprises at least one quaternary ammonium compound selected from aminoalkyl(meth)acrylate polymer quats and at least one quaternary ammonium compound selected from alkoxylated quats, wherein each quaternary ammonium compound comprises an aliphatic C8 to C16 alkyl group.

6. The method according to claim 1, wherein the aminoalkyl(meth)acrylate polymer quat comprises a monomer selected from dimethylaminoethyl(meth)acrylate (DMAEMA) and diethylaminoethyl(meth)acrylate (DEAEMA).

7. The method according to claim 1, wherein the aminoalkyl(meth)acrylate polymer quat is quaternised with an aliphatic C8 to C16 alkyl halide, preferably a C11 to C15 alkyl bromide, particularly bromo-tetradecane.

8. The method according to claim 1, wherein the alkoxylated quat comprise from 2 to 20 alkylene oxide residues in total in the compound and wherein the alkylene oxide residues are selected from ethylene oxide and propylene oxide.

9. The method according to claim 1, wherein the alkoxylated quat comprises from 1 to 4 quaternary ammonium groups.

10. The method according to claim 1, wherein the anti-microbial composition is applied at a loading level of at least 0.1 g of quaternary ammonium compound per m² of substrate surface area (g/m²).

11. The method according to claim 1, wherein the anti-microbial composition is applied at a loading level of at most 20 g of quaternary ammonium compound per m² of substrate (g/m²).

12. An anti-microbial composition, comprising:
a. 0.1 to 15 wt %, based on the total weight of the composition, of one or more quaternary ammonium compounds selected from aminoalkyl(meth)acrylate polymer pats and alkoxylated quats, wherein the or each quaternary ammonium compound comprises an aliphatic C8 to C16 alkyl group;
b. 60 to 99.9 wt %, based on the total weight of the composition, of water;
c. 0 to 25 wt %, based on the total weight of the composition, of organic solvent; and
d. optionally other additives;
wherein the composition is suitable for treating a porous substrate to inhibit or reduce microbial growth in the porous substrate, and wherein the composition does not comprise any further anti-microbial compounds in addition to the quaternary ammonium compound(s).

13. The composition according to claim 12, wherein the composition does not comprise a binder polymer or resin.

14. The composition according to claim 12, wherein the organic solvent comprises a polyalkylene glycol.

15. The composition according to claim 12, wherein the one or more quaternary ammonium compounds comprise at least one quaternary ammonium compound selected from aminoalkyl(meth)acrylate polymer quats and at least one quaternary ammonium compound selected from alkoxylated quats, wherein each quaternary ammonium compound comprises an aliphatic C8 to C16 alkyl group.

16. (canceled)

17. (canceled)

18. (canceled)

19. A method, comprising:
applying at least one quaternary ammonium compound to a porous substrate,
wherein the quaternary ammonium compound is selected from the group of aminoalkyl(meth)acrylate polymer quats, alkoxylated quats and mixtures thereof,
wherein the quaternary ammonium compound comprises an aliphatic C8 to C16 alkyl group,
wherein the quaternary ammonium compound is applied to the porous substrate in a composition which does not comprise a binder polymer or resin, and
wherein the porous substrate is a mineral or textile material.

20. The method of claim 19, wherein the quaternary ammonium compound comprises at least one quaternary ammonium compound selected from aminoalkyl(meth)acrylate polymer quats and at least one quaternary ammonium compound selected from alkoxylated quats, wherein each quaternary ammonium compound comprises an aliphatic C8 to C16 alkyl group.

21. The method according to claim 1, wherein the porous substrate is selected from, concrete, mortar, plaster, grout, masonry, brick, ceramics, woven textiles and non-woven textiles.

22. The composition according to claim 12, wherein the porous substrate is selected from, concrete, mortar, plaster, grout, masonry, brick, ceramics, woven textiles and non-woven textiles.

23. The method of claim 19, wherein the porous substrate is selected from, concrete, mortar, plaster, grout, masonry, brick, ceramics, woven textiles and non-woven textiles.
